(19) United States
(12) Patent Application Publication
(10) Pub. No.: US 2026/0229434 A1
(43) Pub. Date: Aug. 6, 2026

(54) PLUG-IN RELAY

(71) Applicant: SONG CHUAN PRECISION CO., LTD., NEW TAIPEI CITY (TW)

(72) Inventor: SUNG-JEN WU, NEW TAIPEI CITY (TW)

(21) Appl. No.: 19/045,564

(22) Filed: Feb. 5, 2025

(51) Int. Cl. H01H 50/04; H01H 50/14; H01H 50/44

(52) U.S. Cl. CPC H01H 50/048; H01H 50/14; H01H 50/44

(57) ABSTRACT

A plug-in relay includes a base, an outer cover covering the base to define an accommodation space, a wire wheel, a ferrite core, an enameled wire, a stand, a magnetic pole, a spring plate, a plug, a common terminal, a middle elastic plate, and two normally open terminals. The wire wheel is located on the base and has an accommodation slot for accommodating the ferrite core. The enameled wire is wound around the outer surface of the wire wheel. The stand is arranged on a side of the wire wheel. The magnetic pole is an L-shaped plate with a first section and a second section. The plug is fixed to the second section. A common terminal is arranged in the accommodation space. Two normally open terminals are fixed and passed through the base. According to this structure, the plug-in relay can improve applicability in high voltage or harsh environments.

### BACKGROUND OF THE DISCLOSURE

### Technical Field

The present disclosure relates to the field of relays, and particularly relates to a plug-in relay that can greatly improve the applicability in high voltage or harsh environment.

### Description of the Related Art

Electromagnetic relays are operated on the basis of electromagnetic effects and widely used in industrial automation, power systems and communication equipment. The electromagnetic relays have the features of excellent isolation and stability, which are especially essential in multi-channel control. In the face of frequent switching of high currents, electromagnetic relays can effectively prevent the contacts from overheating or melting to ensure the stability of the load and the continuous operation, which make electromagnetic relays an indispensable core component in the switching of electrical loads and circuit protection. In addition, the simple design, cost-effectiveness and high interference resistance make electromagnetic relays to play an important role in applications such as switching control and power load management.

As mentioned above, although the technology of electromagnetic relays is mature, with the rapid development of modern electronic equipment and new energy systems, there is still room for further improvement. In the future, electromagnetic relays will be required to have a higher tolerance to withstand higher power and larger current loads to meet the increasing technical demands and more demanding applications. For example, if the contact spacing of an electromagnetic relay is insufficient when the electromagnetic relay is used in high-voltage environments, it may not be able to maintain normal operation. Considering that the contact spacing of the related-art electromagnetic relays is limited by the internal space of their housings, there is a need to provide a larger contact spacing under the size framework to improve applicability.

In view of the aforementioned deficiencies, the discloser of the present disclosure based on years of rich experience and professional knowledge in the related industry and technological field to propose a novel electromagnetic relay technology solution and attempt to overcome the aforementioned deficiencies of the related art.

### SUMMARY OF THE DISCLOSURE

The primary objective of the present disclosure is to provide a plug-in relay that can be used in high voltage or harsh environments by utilizing a special structural combination of relationships within the space-constrained electromagnetic relay to achieve a larger contact spacing.

To achieve the aforementioned objective, the present disclosure discloses a plug-in relay, including: a base; an outer cover, covering the base to define an accommodation space; a wire wheel, located on and abutted to the base and having an accommodation slot and wire wheel terminals partially passing to the base; a ferrite core, arranged in the accommodation slot; an enameled wire, wound around the outer surface of the wire wheel, and electrically connected to the wire wheel terminals; a stand, arranged on a side of the wire wheel; a magnetic pole, being an L-shaped plate with a first section and a second section, the first section being arranged on a side of the ferrite core, and the second section being provided with an opening; a spring plate, having a bending section and a fixing section, the bending section passing through the opening and abutting the magnetic pole, and the fixing section being fixed to the stand; wherein after the wire wheel terminals are electrically connected, the first section is magnetically attracted by the magnetic pole to abut the ferrite core, and after the wire wheel terminals are electrically disconnected, the first section is restored to its original position by the resilience of the magnetic pole, so that the magnetic pole pivots and swings relative to the stand; a plug, fixed to the second section of the magnetic pole; a common terminal, arranged in the accommodation space; a middle elastic plate, with an end fixed to the common terminal and another end movably pressed and sheathed by the plug; wherein the middle elastic plate has two movable contacts; and two normally open terminals, fixed and passed to the base, and respectively having a fixed contact configured to be corresponding to the movable contacts. The present disclosure uses two sets of opening and closing structures on the same line to achieve the effect of doubling the electrical conduction spacing to improve applicability in high voltage or harsh environments.

Preferably, the plug-in relay of the present disclosure further includes a pair of mounting parts, installed on the base and arranged in the accommodation space, and the pair of mounting parts are fixed to two ends of the common terminal respectively. Further, the pair of mounting parts respectively have a mounting slot provided to cross and be accommodated and mounted to two ends of the common terminal, and the pair of mounting parts together with the common terminal form a door frame structure, so that the middle elastic plate can be swung and accommodated in the door frame structure to increase the spacing between the movable contacts and the fixed contacts in a disconnection state.

Preferably, the common terminal has a first side and a second side, the first side is adjacent to a side of the stand, the second side is opposite to the first side, and the middle elastic plate is riveted to the first side of the common terminal. This arrangement increases the vertical distance from the middle elastic plate to the fixed support by the length of moment arm.

Preferably, the middle elastic plate is riveted to the common terminal, and is upwardly extended to cross the common terminal, downwardly extended a length from the second side, and then extended towards the stand, and the end section of the middle elastic plate is extended downwardly towards the base; and the movable contacts are arranged at an end section of the middle elastic plate.

Preferably, the plug-in relay of the present disclosure further includes a contact plate fixed to an end section of the middle elastic plate, and the movable contacts are passed and installed to the contact plate. This arrangement increases the contact forces and improves heat dissipation.

Preferably, the plug-in relay of the present disclosure further includes a pair of current sensors fixed to the normally open terminals outside the accommodation space respectively. This arrangement allows the plug-in relay to monitor the status of use.

Preferably, the middle elastic plate is made of a plurality of laminated metal sheets and the laminated metal sheets is made of different materials according to an applicable situation in order to enhance applicability.

In summation of the description above, the plug-in relay of the present disclosure uses two sets of opening and closing structures on the same line to achieve twice the electrical conduction spacing to improve applicability in high voltage or harsh environments. Further, based on this, the pair of mounting parts together with the common terminal form the door frame structure, so that the middle elastic plate can be swung and accommodated in the door frame structure, thereby further increasing the spacing between the movable contacts and the fixed contacts in the disconnection state. In addition, the middle elastic plate is installed at a special position of the common terminal to further improve the stability of the contact points in the contact and disconnection states. The special bending configuration of the middle elastic plate is provided to further increase the spacing between the movable contacts and the fixed contacts in the disconnection state. On the other hand, considering the overall stability and service life of the plug-in relay, a contact plate can be added to increase the contact force and improve heat dissipation. The current sensor is used to monitor the status of use. At the same time, the middle elastic plate is implemented with a plurality of laminated metal sheets which can be made of different materials to improve applicability.

### BRIEF DESCRIPTION OF THE DRAWINGS

FIG. 1 is a schematic view showing the structure of a plug-in relay in accordance with one preferred embodiment of the present disclosure;

FIG. 2 is a schematic view showing the assembly of a plug-in relay in accordance with one preferred embodiment of the present disclosure;

FIG. 3 is a schematic view of a plug-in relay in an electrical disconnection state in accordance with one preferred embodiment of the present disclosure;

FIG. 4 is a schematic view of a plug-in relay in an electrical contact state in accordance with one preferred embodiment of the present disclosure;

FIG. 5 is a schematic view of a middle elastic plate with a structure made of a plurality of laminated metal sheets in accordance with one preferred embodiment of the present disclosure; and

FIG. 6 is a schematic view of a plug-in relay with a current sensor in accordance with one preferred embodiment of the present disclosure.

### DESCRIPTION OF THE PREFERRED EMBODIMENTS

The following description together with the attached drawings are provided to enable people having ordinary skill in the art to clearly understand the technical contents of the present disclosure.

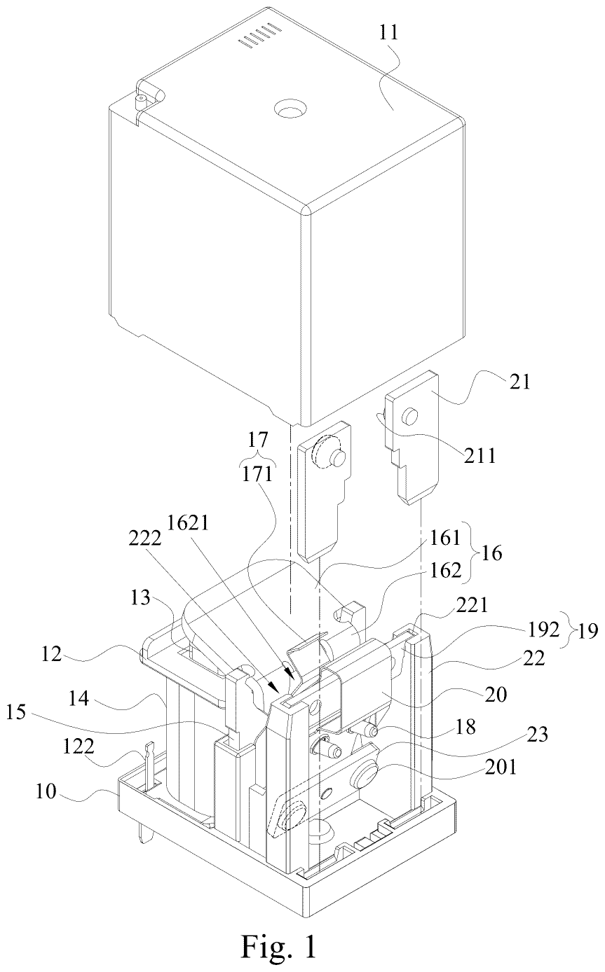

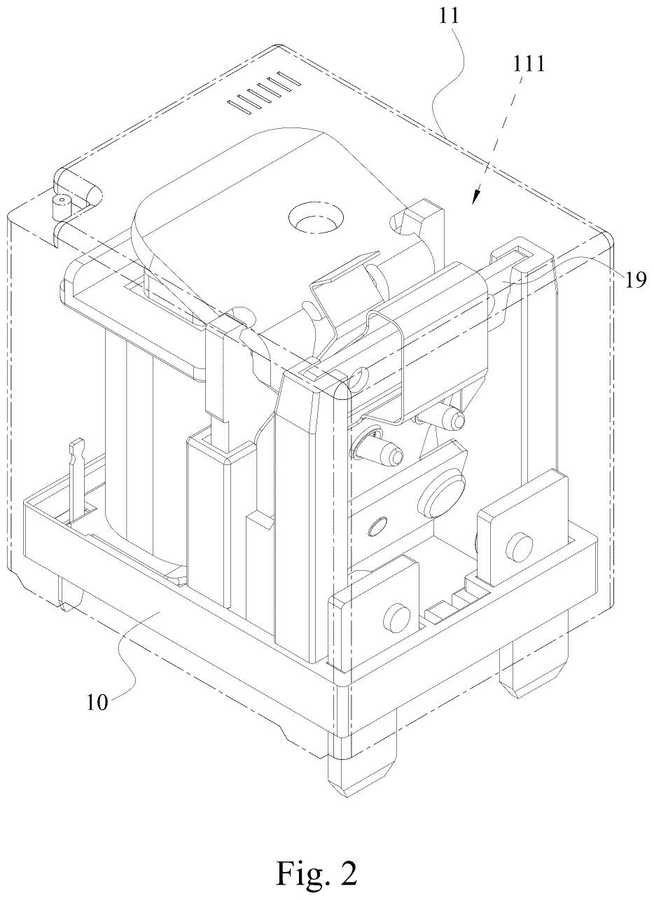

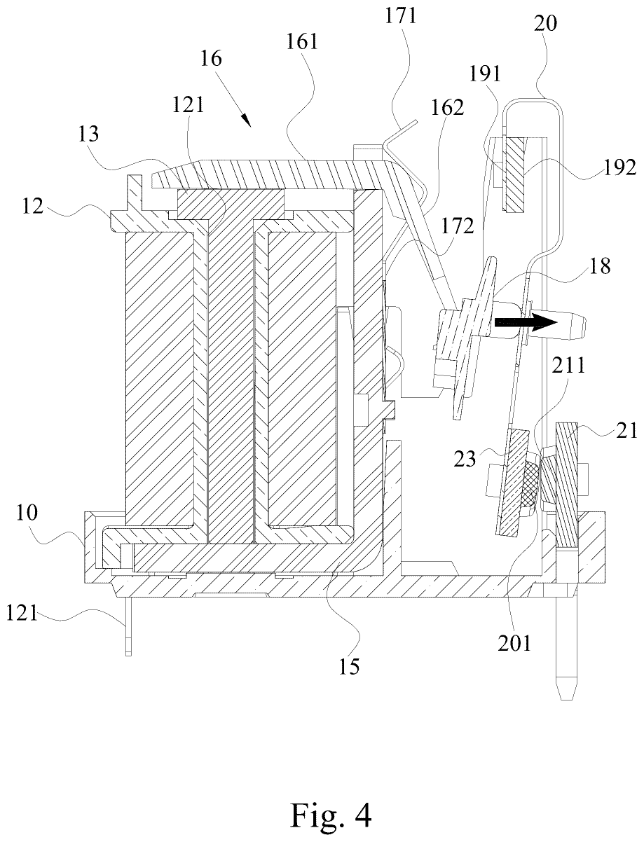

With reference to FIGS. 1 to 4 for the plug-in relay structure diagram, assembly diagram, disconnection state diagram and contact state diagram of one preferred embodiment of the present disclosure respectively, a plug-in relay of the present disclosure includes a base 10, an outer cover 11, a wire wheel 12, a ferrite core 13, an enameled wire 14, a stand 15, a magnetic pole 16, a spring plate 17, a plug 18, a common terminal 19, a middle elastic plate 20 and two normally open terminals 21. The outer cover 11 covers the base 10 to define an accommodation space 111 between the base 10 and the outer cover 11 for accommodating a plurality of components of the plug-in relay. Further, the wire wheel 12 is located on and abutted to a side of the base 10, the wire wheel 12 has an accommodation slot 121 and a plurality of wire wheel terminals 122, and the wire wheel terminals 122 are partially passed and installed to the base 10. The ferrite core 13 is arranged in the accommodation slot 121, the enameled wire 14 is wound around an outer surface of the wire wheel 122 to wrap the ferrite core 13, the enameled wire 14 and the wire wheel terminals 122 are electrically connected to each other, to form a distribution of magnetic lines of force electromagnetic induction with the ferrite core 13 after the electrical connection. In addition, the stand 15 is installed on the base 10 and arranged on a side of the wire wheel 12, the magnetic pole 16 is an L-shaped plate with a first section 161 and a second section 162, wherein the first section 161 is arranged on a side of the ferrite core 13, the second section 162 is provided with an opening 1621. The spring plate 17 has a bending section 171 and a fixing section 172, the bending section 171 passes through the opening 1621 and abuts the magnetic pole 16, the fixing section 172 is fixed to the stand 15. During operation, after the wire wheel terminals 122 are electrically connected, the first section 161 of the magnetic pole 16 abuts the ferrite core 13 through the magnetic attraction generated by the electromagnetic induction, and after the wire wheel terminals 122 are electrically disconnected, the first section 161 of the magnetic pole 16 restores its original position by the resilience of the abutting spring plate 17, so as to pivot and swing the magnetic pole 16 relative to the stand 15, and the plug 18 is fixed to the second section 162 of the magnetic pole 16 so that when the magnetic pole 16 pivots and swing, which drives the plug 16 to move away from the stand 15. Further, the common terminal 19 is fixed in the accommodation space 111 and fixed to an end of the middle elastic plate 20, and another end of the middle elastic plate 20 is movably abutted and sheathed by the plug 18. The middle elastic plate 20 has two movable contacts 201. The normally open terminals 21 are fixed and passed to the base 10, and the normally open terminals 21 respectively have a fixed contact 211, and the fixed contacts 211 are configured to be corresponding to the movable contacts 201. In other words, after the magnetic pole 16 is electrically connected, the first section 161 is magnetically attracted to abut the ferrite core 13 to pivot and swing, and the second section 162 will drive the plug 16 to move forward together and to push the middle elastic plate 20 for a displacement. At this time, the movable contacts 201 are in contact with the fixed contacts 211 respectively to define an electrical contact state. The plug-in relay is in the limited accommodation space 111, and uses two sets of opening and closing structures in the same circuit, so that the conduction spacing can be doubled to greatly improve the applicability in high voltage or harsh environments.

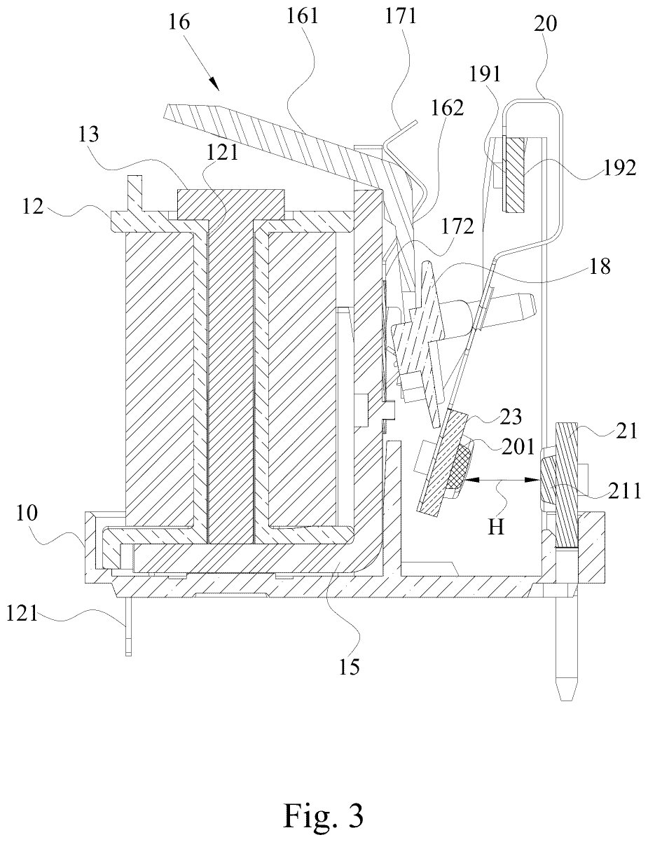

In addition, the plug-in relay realizes the effects of doubling the conduction spacing through two sets of opening and closing structures and increasing the distance between contacts. There is a way to increase the contact spacing H of the present disclosure as shown FIG. 3, wherein the plug-in relay further includes a pair of mounting parts 22 installed on the base 10 and arranged in the accommodation space 111, and the pair of mounting parts 22 are fixed to two ends of the common terminal 19 respectively. Further, the pair of mounting parts 22 respectively have a mounting slot 221 provided for two ends of the common terminal 19 to cross, be accommodate and installed, such that the pair of mounting parts 22 together with the common terminal 19 form a door frame structure 222, and the middle elastic plate 20 can be swung and accommodated in the door frame structure 222.

Traditionally, since the accommodation space 111 is limited, therefore the middle elastic plate 20 is normally limited by the installation conditions of other components to restrict its swinging range. Through the special design of the door frame structure 222, the swinging range of the middle elastic plate 20 can be increased in the limited space, thereby increasing the contact spacing.

In order to improve the stability of the connection and disconnection between the contacts, the plug-in relay of the present disclosure attempts to increase the length of the moment arm of the vertical distance from the line of force of the middle elastic plate 20 to the fixed fulcrum, which is accomplished by the special connection between the middle elastic plate 20 and the common terminal 19. Wherein, the common terminal 19 is defined with a first side 191 and a second side 192, the first side 191 is adjacent to a side of the stand 15, the second side 192 is opposite to the first side 191, and the middle elastic plate 20 is riveted and installed to the first side 191 of the common terminal 19 to achieve the aforementioned effect.

In addition, the distance between the contacts of the present disclosure is increased. In addition to the aforementioned improvement of using the door frame structure 222 to accommodate the middle elastic plate 20, the present disclosure further provides a special bending design for the middle elastic plate 20 itself to further increase the distance between the movable contacts 201 and the fixed contacts 211 in the disconnection state. The method is to install the middle elastic plate 20 at the common terminal 19 by riveting, upwardly extend the middle elastic plate 20 across the common terminal 19, downwardly extend the middle elastic plate 20 a length from the second side 192, and then extend the middle elastic plate 20 toward a side of the stand 15. The end section of the middle elastic plate 20 extends downwardly toward the base 10, and the movable contacts 201 are arranged at the end of the middle elastic plate 20, so that the expected effect can be achieved.

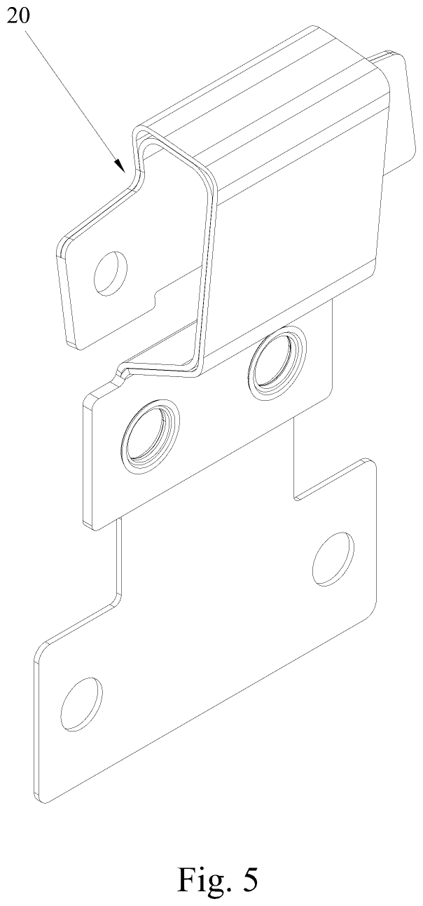

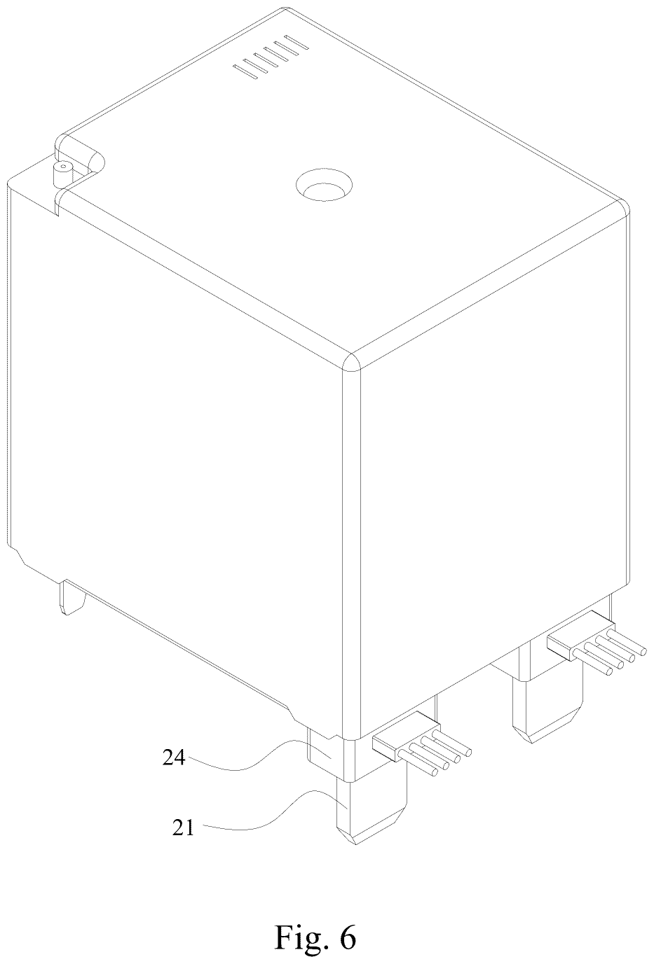

In FIGS. 1 to 6, the description of FIGS. 1 to 4 have been given above and will not be repeated, FIG. 5 shows the structure of a middle elastic plate made of a plurality of laminated metal sheets in accordance with one preferred embodiment of the present disclosure, and FIG. 6 shows a plug-in relay with a current sensor in accordance with one preferred embodiment of the present disclosure. Based on the structure of the above embodiment, in order to improve the overall stability and service life of the plug-in relay, the plug-in relay further includes a contact plate 23 fixed to an end section of the middle elastic plate 20, and the movable contacts 201 are passed through the contact plate 23, thereby increasing the contact force and improving the heat dissipation when the contact is electrically conducted. The plug-in relay of the present disclosure further includes a pair of current sensors 24 fixed the normally open terminals 21 outside the accommodation space 111 respectively for monitoring the usage status and evaluate tolerance. In different applicable situations, the voltage and current tolerance requirement may also be different. Therefore, the middle elastic plate 20 can be made of a plurality of laminated metal sheets in the plug-in relay of the present disclosure, and the laminated metal sheets can be made of different materials to improve applicability.

In summary, the plug-in relay of the present disclosure doubles the conduction spacing by providing two sets of opening and closing structures in the same a circuit, thereby enhancing its applicability in high-voltage and harsh environments. On this basis, the mounting part and common terminal are used together to form the door frame structure, the middle elastic plate can flexibly swing and be accommodated in the door frame structure, thus effectively increasing the distance between the movable contacts and the fixed contacts in the disconnection state, and enhancing the safety and reliability of the disconnection process. In addition, the middle elastic plate is installed at a specific position of the common terminal to further strengthen the moment arm of the middle elastic plate to ensure the stability of the contact between the contacts in the contact and disconnection states. Furthermore, the special bending design of the middle elastic plate increases the distance between the movable contacts and the fixed contacts in the disconnection state to increase the safety in the event of disconnection. In addition, the middle elastic plate is made of a plurality of laminated metal sheets, and these laminated metal sheets may be made of different materials to further improve the adaptability of the relays in diverse applications and ensure stable operation under different working conditions. At the same time, in order to improve the overall stability of the plug-in relay and extend its service life, a contact plate can be added to strengthen the contact pressure and improve the heat dissipation effect. In addition, a current sensor is installed to monitor the operation status in real time to ensure the stability and safety of the operation. In addition, the middle elastic plate consists of several layers of laminated metal sheets, which can be made of different materials to further improve the adaptability of the relay in a variety of applications and ensure stable operation under different operating conditions.

What is claimed is:

1. A plug-in relay, comprising:
a base;
an outer cover covering the base to define an accommodation space defined between the base and the outer cover;
a wire wheel, located on and abutted to the base, having an accommodation slot and a plurality of wire wheel terminals, and the plurality of wire wheel terminals partially passing through the base;
a ferrite core arranged in the accommodation slot;
an enameled wire wound around an outer surface of the wire wheel for wrapping the ferrite core therein, and the enameled wire being electrically coupled to the plurality of wire wheel terminals;
a stand installed on the base and arranged on a side of the wire wheel;
a magnetic pole, being an L-shaped plate, having a first section and a second section, wherein the first section is arranged on a side of the ferrite core, and the second section is provided with an opening;
a spring plate having a bending section and a fixing section, the bending section passing through the opening and abutting the magnetic pole, the fixing section being fixed to the stand, wherein, after the plurality of wire wheel terminals is electrically conducted, the first section of the magnetic pole is magnetically attracted to abut against the ferrite core, and after the plurality of wire wheel terminals is electrically disconnected, the first section of the magnetic pole moves back to an original position by a resilience of the spring plate, so that the magnetic pole pivots and swings relative to the stand;
a plug fixed to the second section of the magnetic pole;
a common terminal fixed in the accommodation space;
a middle elastic plate with an end fixed to the common terminal and another end movably pressed and sheathed by the plug, wherein the middle elastic plate has two movable contacts; and
two normally open terminals fixed on and passed through the base, each of the two normally open terminals having a fixed contact, and the fixed contact located at a position corresponding to the two movable contacts respectively.

2. The plug-in relay according to claim 1, further comprising:
a pair of mounting parts installed on the base and arranged in the accommodation space, and the pair of mounting parts being fixed to two ends of the common terminal respectively.

3. The plug-in relay according to claim 2, wherein the pair of mounting parts have a mounting slot, respectively, provided for crossing, accommodating, and mounting the two ends of the common terminal, and the pair of mounting parts and the common terminal form a door frame structure, so that the middle elastic plate is swingable and accommodatable in the door frame structure.

4. The plug-in relay according to claim 3, wherein the common terminal has a first side and a second side, the first side is adjacent to a side of the stand, the second side is opposite the first side, and the middle elastic plate is riveted to the first side of the common terminal.

5. The plug-in relay according to claim 4, wherein the middle elastic plate is riveted to the common terminal, and is upwardly extended to cross the common terminal, downwardly extended a length from the second side, and then extended towards the stand, and an end section of the middle elastic plate is extended downwardly towards the base, and
the two movable contacts are arranged at the end section of the middle elastic plate.

6. The plug-in relay according to claim 5, further comprising a contact plate fixed to the end section of the middle elastic plate, and the two movable contacts being passed through and installed on the contact plate.

7. The plug-in relay according to claim 6, further comprising a pair of current sensors fixed to the two normally open terminals outside the accommodation space respectively.

8. The plug-in relay according to claim 7, wherein the middle elastic plate is made of a plurality of laminated metal sheets.

9. The plug-in relay according to claim 8, wherein the plurality of laminated metal sheets is made of different materials.
